(19) United States
(12) Patent Application Publication
(10) Pub. No.: US 2009/0112450 A1
(43) Pub. Date: Apr. 30, 2009

(54) Fuel Management System for Refueling a Fuel System for Improved Fuel Efficiency Utilizing Glycols

(76) Inventor: Daniel Stedman Connor, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/252,383

(22) Filed: Oct. 16, 2008

Related U.S. Application Data
(60) Provisional application No. 61/001,226, filed on Oct. 31, 2007.

(51) Int. Cl. F02D 45/00

(52) U.S. Cl. 701/111

(57) ABSTRACT

A fuel management system of a vehicle and a refueling system for gasoline stations to handle a fuel system for improved fuel efficiency which can be contained in a fuel tank having a gasoline phase comprises gasoline or gasohol; and an anti-knock phase comprising an anti-knock agent comprising a glycol anti-knock subagent, water and one or more of a second anti-knock subagent selected from the group of methanol, ethanol and mixtures thereof, such that the anti-knock agent phase is substantially immiscible with the gasoline phase.

### CROSS REFERENCE TO RELATED APPLICATION

The present application claims priority to provisional U.S. application Ser. No. 61/001226, filed Oct. 31, 2007.

### FIELD OF THE INVENTION

A fuel management system of a vehicle and a refueling system for gasoline stations to handle a fuel system for improved fuel efficiency which can be contained in a fuel tank having a gasoline phase comprises gasoline or gasohol; and an anti-knock phase comprising an anti-knock agent comprising a glycol anti-knock subagent, water and one or more of a second anti-knock subagent selected from the group of methanol, ethanol and mixtures thereof, such that the anti-knock agent phase is substantially immiscible with the gasoline phase.

### BACKGROUND OF THE INVENTION

The present invention relates to a fuel management system for use with spark ignition gasoline engines in which an anti-knock agent is directly injected into a combustion chamber, such as a cylinder of the engine. The present invention further relates to a fuel pump system which communicates with the fuel management system for dispensing of the anti-knock agent and gasoline as needed.

It is known to replace a portion of gasoline with small amounts of ethanol added at the fuel distributor blending rack. Ethanol is attractive because it is a renewable energy, biomass-derived fuel, but the small amounts of ethanol that have generally heretofore been added to gasoline have had a relatively small impact on engine performance.

It is known that restricting the use of ethanol in a spark ignition gasoline engine to the relatively small fraction of time in an operating cycle when it is needed to prevent knock in a higher load regime and by minimizing its use at these times, the amount of ethanol that is required can be limited to a relatively small fraction of the fuel used by the spark ignition gasoline engine. See US 2006/0102145 and US 2006/0102146. However, the proposed method of delivering the ethanol to the gasoline engine is to use two separate tanks. It is a recognized challenge whether consumers will mind filling up with two fuels in two different fuel tanks. Boston Globe, Apr. 22, 2007, Third Edition, O'Brien, Keith, “Fill 'er up. But with what?—In the fevered search for the fuel of tomorrow, a team of MIT scientists have a surprising solution that just might be the most realistic one of all.” Additional proposed solutions include the use of onboard separation methods of ethanol from a gasoline such as fractional distillation or membrane separation. See US 2006/0102136. Gasoline and anhydrous ethanol are miscible in any ratio, i.e., they can be mixed without occurrence of a separate liquid phase. When a certain amount of water is present, however, a separate liquid layer will occur. The occurrence of a separate liquid phase in gasohol is perceived as harmful even though the phase behavior of gasoline-ethanol-water mixtures is totally different from gasoline-water mixtures. See WO06/137725.

Variable octane gasoline fuel systems including two different octane gasoline fuels stored separately has been discussed in US20050252489A1.

A method for refueling motor vehicles and devices for data transmission between a vehicle and a gas pump have been discussed in US 2006/0196571A1.

However these proposed solutions require a change in consumer habits in filling their vehicles or require complex technical changes to existing gasoline systems in vehicles. A solution is still needed that provides a simplified fuel management system that requires little to no change in the consumer habits when filling their vehicles with gasoline.

### SUMMARY OF THE INVENTION

The present invention relates to a fuel management system for a gasoline engine comprising an engine comprising a cylinder; a fuel processor system; a knock sensor in communication with the engine and the fuel processor system; a combustion chamber injector in communication with the fuel processor system preferably located tangential to the combustion chamber; a manifold or port area; and a fuel tank comprising: gasoline in an upper gasoline layer, a gasoline fuel level detection device in communication with the fuel processor system; a gasoline feed fluidly connecting the gasoline in the fuel tank to the manifold or port area; and anti-knock agent in a lower anti-knock agent layer; an anti-knock agent level detection device in communication with the fuel processor system; an anti-knock agent feed fluidly connecting the anti-knock agent to the combustion chamber injector.

The present invention further relates to a refueling system for a vehicle comprising a vehicle comprising a fuel management system and fuel dispenser capable of being temporarily fluidly connected to a gasoline source and an anti-knock source, the fuel dispenser comprising a dispenser control system and a fuel dispensing assembly; wherein the fuel dispensing assembly is able to deliver the gasoline source, anti-knock source or a mixture thereof from the fuel dispenser to the fuel tank; the dispenser control system is able to detect a fuel processor, receive data from the fuel processor and transfer data to the fuel processor.

### BRIEF DESCRIPTION OF THE DRAWINGS

FIG. 1 is a schematic diagram of the fuel management systems discussed herein.

FIG. 2 is a schematic diagram of the refueling system discussed herein.

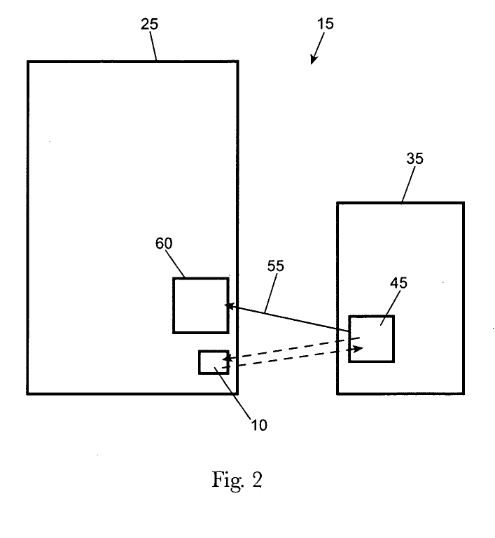

### DETAILED DESCRIPTION OF THE INVENTION

Utilization of a separate anti-knock agent through an injector system in an internal combustion engine allows for production of a lower octane base gasoline thereby opening the possibility of refineries deriving a higher yield of gasoline from a given amount of crude and increase the gasoline throughput of refineries. It would also give the potential to lower complexity of refineries lowering capital requirements and energy required to refine given crude to gasoline.

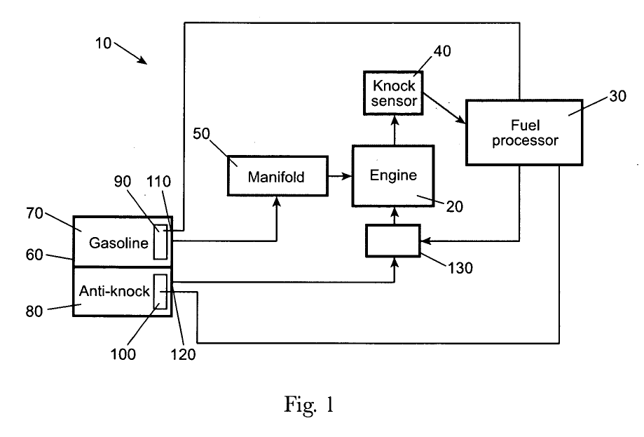

With reference first to FIG. 1, a fuel management system (10) includes a gasoline engine (20) having at least one cylinder, a fuel processor system (30), a knock sensor (40), a manifold (50), a combustion chamber injector (130) and a fuel tank (60). The fuel processor system (30) controls the direct injection of an antiknock agent from a combustion chamber injector (130) that is fluidly connected to a fuel tank (60). The fuel tank (60) also contains gasoline or gasohol (collectively or individually referred to herein as gasoline). The fuel management system (10) also affects the delivery of gasoline from the fuel tank (60) into manifold (50) or port area. The fuel management system (10) also communicates with other components of the system (10) as discussed further below.

The fuel tank (60) comprises level detection devices (90, 100) for the gasoline and anti-knock agent which indicates the levels (empty, full, or some fraction) of the gasoline layer and the anti-knock agent layer in the fuel tank (60). In one embodiment, the gasoline fuel level detection device comprises a float having buoyancy to be located on top of the gasoline layer. In one embodiment, the anti-knock agent level detection device comprises a float having buoyancy to be located on top of the anti-knock layer, but not having buoyancy in the gasoline layer. The fuel tank (6) preferably comprises a baffle system of two or more baffles to restrict the lateral movement of the gasoline layer and the anti-knock agent layer. The level detection devices (90, 100) are individually in communication with the fuel processor system (30) and can individually transmit information regarding the level of gasoline and/or anti-knock agent. This information can be used for informing the vehicle user and may be used to inform other devices such as a gasoline pump at a gas station. The fuel tank (60) further comprises at least two feeds to the gasoline engine (20), the first feed for the gasoline (gasoline feed [110]) and a second feed for the anti-knock agent (anti-knock feed [120]). The gasoline feed (110) is located such that gasoline in a gasoline layer is able to be fluidly conveyed from the fuel tank (60) into manifold (50) or port area, without the anti-knock agent being fluidly conveyed by the gasoline feed (110). The anti-knock feed (120) is located such that the anti-knock agent in an anti-knock layer is able to be fluidly conveyed from a fuel tank (60) to the combustion chamber injector (130) without the gasoline being fluidly conveyed by the anti-knock feed (120).

The amount of anti-knock agent injected is dictated either by a predetermined correlation between octane number enhancement and fraction of fuel that is provided by anti-knock agent or by a control system that uses a signal from the knock sensor (40) as an input to the fuel management system (10). In both situations, the fuel management system (10) can minimize the amount of anti-knock agent added to a cylinder while still preventing knock.

The anti-knock agent is directly injected from the combustion chamber injector (130) into the gasoline engine (20) via a combustion zone, such as a cylinder. Using a signal from a knock sensor to determine when and how much anti-knock agent must be used at various times in a drive cycle to prevent knock, the fuel management system (10) can be employed to minimize the amount of anti-knock agent that is consumed over the drive cycle. If sufficient anti-knock agent is available locally or nationally, the fuel management system (10) can also be used to employ more anti-knock agent than would be needed to prevent knock.

Direct injection substantially increases the benefits of anti-knock agent addition and decreases the required amount of anti-knock agent. Recent advances in fuel injector and electronic control technology allows for tightly controlled amounts of fuel at high pressures injected directly into an engine cylinder in very short time frames rather than into the manifold (50). A combustion chamber injector (130) is provided for direct injection of the anti-knock agent into a combustion zone such as a cylinder of the gasoline engine (20) and a fuel processor system (30) controls injection of the anti-knock agent into the combustion zone such as a cylinder to control knock. The injection of the antiknock agent can be initiated by a signal from a knock sensor (40), initiated when the engine torque is above a selected value or fraction of the maximum torque where the value or fraction of the maximum torque is a function of the engine speed or initiated upon an increase in pressure on an accelerator pedal of a vehicle or a rate of change in position of the accelerator pedal of the vehicle. In one embodiment, the combustion chamber injector (130) injects the anti-knock agent after inlet valve/valves are closed in the cylinder. In one embodiment the injector (20) injects the anti-knock agent tangentially into the combustion zone or cylinder, preferably to the upper portion of the combustion zone or upper portion of the cylinder.

In the case of anti-knock agent direct injection the charge is directly cooled. The high heat of vaporization of the anti-knock agent with its direct injection late in the cycle gives the desired impact of knock suppression. The temperature decrease of the air and unburned fuel in the cylinder increases with the amount of oxygen in the anti-knock agent (in terms of the O:C ratio of the anti-knock molecule(s)). It is also useful to compare ratios of the heat of vaporization to the heat of combustion, a measure of the potential effects when used as anti-knock agents. This parameter gives a measure of the amount of evaporative cooling for a given level of torque.

It is assumed that the air/fuel mixture is stoichiometric without exhaust gas recirculation (EGR), and that gasoline makes up the rest of the fuel. In the embodiment of FIG. 1 port fuel injection of the gasoline in which the gasoline is injected into the manifold. Gasoline is vaporized in the inlet manifold and does not contribute much to cylinder charge cooling.

Thus when variable anti-knock agent octane enhancement is employed, the fuel processor system (30) needs to adjust the amounts of air, gasoline and anti-knock agent such that it is stoichiometric. The additional control is needed because, if the air/fuel ratio determined by the fuel processor system (30) were not corrected during the injection of anti-knock agent, the mixture would no longer be stoichiometric. Preferably the fuel processor system (30) can choose between fluidly conveying the anti-knock agent and gasoline.

Gasoline/Gasohol Phase

As used herein “gasoline” refers to a mixture of hydrocarbons boiling in the approximate range of 40° C. to 210° C. and that can be used as fuel for internal combustion engines (e.g., motor gasoline as defined by ASTM Specifications D-439-89). Gasoline may contain substances of various natures, which are added in relatively small amounts, to serve a particular purpose, such as to increase the octane number, biocides, antifungals, anticorrosion agents or other benefit agents.

As used herein “gasohol” refers to a mixture of gasoline and an alcohol, typically ethanol (see ASTM D-4814-91). The ethanol content is from 1 to 85 volume %. Typically the ethanol content is from 5 to 10 volume %. Ethanol is typically fermented from grain (corn, wheat, barley, oats, sugar beets, cane sugar, etc.) in a fermentation process. In the future, ethanol may be produced from biomass such as switch grass, waste wood, fibers and other carbohydrates. The ethanol is blended into gasoline in various quantities. Octane of gasoline or gasohol may be measured according to ASTM Method D2700.

Gasoline is utilized in the discussion herein to encompass both gasoline and gasohol as defined herein for ease in communication and is not intended to limit the discussion to solely gasoline.

As used herein, the term “immiscible” regarding the gasoline phase and the anti-knock agent phase means two or more distinct separate phases the components of one phase are largely confined to that phase. As used herein, the term “substantially free of the anti-knock agent layer” means the gasoline layer or phase comprises less than 10 vol % of the anti-knock agent, preferably less than 5 vol % of the anti-knock agent in the gasoline layer or phase. Similarly, as used herein, the term “substantially free of the gasoline layer” the anti-knock agent layer or phase comprises less than 10 vol % of gasoline, preferably less than 5 vol % of the gasoline layer or phase in the anti-knock agent. The gasoline layer or phase should comprise less than 0.1 vol % water.

As used herein, the term “fuel” means any combustible materials including the gasoline, gasohol, anti-knock agents such as the glycol anti-knock agent and second anti-knock agent.

The goal of this application is to define conditions under which two distinct phases form.

Anti-Knock Phase

The present invention includes an anti-knock phase comprising an anti-knock agent comprising a glycol anti-knock subagent, water, and a second antiknock subagent selected from the group comprising methanol, ethanol and mixtures thereof, wherein the anti-knock agent phase is substantially immiscible with the gasoline phase.

Anti-Knock Agent

It is preferred that the anti-knock agent have a heat of vaporization that is at least twice that of gasoline or a heat of vaporization per unit of combustion energy that is at least three times that of gasoline. The octane enhancement effect as discussed herein refers primarily to the decrease in the engine octane requirement. However a smaller but real increase in octane of the fuel itself will result from the ethanol. Direct injection of gasoline results in approximately a five octane number decrease in the octane number required by the engine, as discussed by J. Stokes, T. H. Lake and R. J. Osborne, “A Gasoline Engine Concept for Improved Fuel Economy—The Lean Boost System,” SAE paper 2000-01-2902 Thus the contribution is about five octane numbers per 30K drop in charge temperature. Without being bound by theory, it is believed that the anti-knock agent can decrease the charge temperature of the end gases, then the decrease in octane number required by the engine due to the drop in temperature.

The amounts discussed herein may be for the anti-knock agent or the gasoline dispensed into the fuel tank (fuel tank) or it may be amounts for the anti-knock agent or the gasoline before injected into the engine. As can be seen in the examples of the present application, once the anti-knock agent is dispensed into the fuel tank, it mixes with the gasoline before separating into a distinct phase. However, gasoline may be somewhat soluble in the anti-knock layer and ethanol may be somewhat soluble in gasoline, thereby changing the volume percentages stated herein.

Anti-Knock Agent

Glycol Anti-Knock Subagent

The large heat of vaporization of the anti-knock agent, there could be enough charge cooling with early injection so that the rate of vaporization of anti-knock agent is substantially decreased. The high heat of vaporization of the anti-knock agent with its direct injection late in the cycle especially into the end gases gives the desired impact of knock suppression. The temperature decrease of the air in the cylinder increases with the amount of oxygen in the fuel (in terms of the O:C ratio of the glycol anti-knock subagent molecule(s)). It is also useful to compare ratios of the heat of vaporization to the heat of combustion, a measure of the potential effects when used as anti-knock agents. This parameter gives a measure of the amount of evaporative cooling for a given level of torque.

The glycol anti-knock subagent is selected such that the ratio of oxygen atoms present in the molecule and carbon atoms present in the molecule is from 0.4 to 1.0.

The glycol anti-knock agent can act as antifreeze in aqueous solutions especially if octane enhancer is supplied to gas station pump substantially as a glycol water solution. This addresses identified issues with water being present in gasohol mixtures and freezing issues at temperatures of 0° C. or lower. In one embodiment, the glycol anti-knock agent can demonstrate improved safety for transportation as glycol and water are essentially non-flammable mixtures (“non-flammable”) having a high flash point compared to ethanol and ethanol mixtures. Additionally, glycol anti-knock agents are known to be biodegradable.

The glycol anti-knock subagent may be selected from glycols of natural origin, preferably glycols derived from hydrolysis of fats and oils, made by fermentation of carbohydrates to give a naturally derived glycol or by hydrogenation of glycols of natural origin. Alternatively, the glycol anti-knock subagent may be selected from glycol of petrochemical origin, preferably by the oxidation and hydration of olefins to give a petrochemical glycol.

The glycol anti-knock subagent is selected from the group consisting of glycerol (O:C ratio of 1:1), ethylene glycol (O:C ratio of 1:1 or 1), 1,2-propylene glycol (O:C ratio of 2:3 or 0.67), 1,3-propylene glycol (O:C ratio of 2:3 or 0.67), isobutylene glycol, 1,2-butanediol (O:C ratio of 1:2 or 0.5), 1,3-butanediol (O:C ratio of 1:2 or 0.5), 2,3-butanediol (O:C ratio of 1:2 or 0.5), 1,4-butanediol (O:C ratio of 1:2 or 0.5), C₅ diols (O:C ratio of 2:5 or 0.4) such as 1,2 pentanediol, 1,5-pentanediol, 1,4-pentanediol, 2,3-pentanediol, amylene diols (O:C ratio of 2:5 or 0.4), C₆ diols (O:C ratio of 2:6 or 0.3) such as 1,2-hexanediol, 1,6-hexanediol, 2,3-hexanediol and mixtures thereof. Preferably the glycol anti-knock subagent is selected from glycerol, 1,2-propylene glycol, 1,3-propylene glycol and mixtures thereof.

The anti-knock agent comprises less than 40% by volume of glycol anti-knock agent by volume of the anti-knock agent, preferably comprising from about 5% by volume to about 40% by volume of glycol anti-knock agent by volume of the anti-knock agent as dispensed into the single fuel source (fuel tank), wherein the anti-knock agent then separates out as the anti-knock layer.

Water should be present in sufficient amounts in order to effectively result in the anti-knock agent being in a distinct layer. Water comprising at least 10% by volume of the anti-knock agent as dispensed into the single fuel source (fuel tank), preferably water comprising from about 10% by volume to about 30% by volume of the anti-knock agent as dispensed into the single fuel source (fuel tank).

Second Anti-Knock Subagent

The second anti-knock subagent selected from the group of methanol, ethanol and mixtures thereof. In one embodiment, the second anti-knock subagent is selected as ethanol. The ethanol anti-knock subagent may be wholly derived by extraction from gasohol at the time of dispensing or may be part of the anti-knock agent as delivered to the gas station

Additional Additives

The fuel system may also comprise additional additives. These additives may include, but are not limited to anti-knock agents not described above, corrosion inhibitors, surfactants, detergents, metal deactivators, antioxidants, fuel stabilizers, and anti-freeze components. Examples of anti-knock agents other than those discussed above include lead alkyls such as tetraethyl lead and tetramethyl lead; manganese compounds such as methylcyclopentadienyl manganese tricarbonyl; and iron compounds such as ferrocene. An example a corrosion inhibitor is SPEC-AID 8Q103 available from GE Betz, Inc.

Examples demonstrating phase separation after mixing. Gasoline is represented by a hexane/toluene mixture.

All parts by volume—10 mL gasohol (Hex/Tol/EtOH); 5 mL EtOH/PG/H₂O

EtOH being ethanol; PG being propylene glycol; H₂O being water; Hex being hexane; Tol being toluene. Add the mixture to a stoppered graduated cylinder and shake vigorously for 30 seconds and allow the layers to separate.

| | | | | | | | | | | Sec | Sec | |
|---|---|---|---|---|---|---|---|---|---|---|---|---|
| | | | | x | | | | | Bottom | to | to | |
| | | | | (EtOH | y (PG | | | | Layer | clear | clear | |
| EtOH | PG | H₂O | x/y | H₂0) | H₂O) | Hex | Tol | EtOH | mL | 23° C. | 0° C. | Visual |
| 52.5 | 17.5 | 30 | 75/25 | 70 30 | 70 30 | 80 | 10 | 10 | 5.5 | 12 | 24 | Clear |
| | | | | | | | | | | | | (top |
| | | | | | | | | | | | | fast |
| | | | | | | | | | | | | bottom |
| | | | | | | | | | | | | slow) |
| 60 | 20 | 20 | 75/25 | 80 20 | 80 20 | 80 | 10 | 10 | 5.5 | 11 | 22 | Clear |
| | | | | | | | | | | | | (top |
| | | | | | | | | | | | | fast |
| | | | | | | | | | | | | bottom |
| | | | | | | | | | | | | slow |
| 63.75 | 21.25 | 15 | 75/25 | 85 15 | 85 15 | 80 | 10 | 10 | 6.8 | 11 | 14 | clear |
| 67.5 | 22.5 | 10 | 75/25 | 90 10 | 90 10 | 80 | 10 | 10 | 6.8 | 19 | 14 | clear |
| 71.25 | 23.75 | 5 | 75/25 | 95 5 | 95 5 | 80 | 10 | 10 | 6.8 | 20 | 28 | clear |
| 75 | 25 | 0 | 75/25 | 100 0 | 100 0 | 80 | 10 | 10 | miscible | | | |
| 40 | 40 | 20 | 50/50 | 80 20 | 80 20 | 80 | 10 | 10 | 6.0 | 23 | 26 | Top |
| | | | | | | | | | | | | clear |
| | | | | | | | | | | | | Bottom |
| | | | | | | | | | | | | hazy |

All Measurements by Volume

10 mL gasohol (Hex/Tol/EtOH); 5 mL EtOH/gly/H₂O

EtOH being ethanol; Gly being glycerol; H₂O being water; Hex being hexane; Tol being toluene. Add the mixture to a stoppered graduated cylinder and shake vigorously for 30 seconds and allow the layers to separate.

| | | | | | | | | | | Sec | Sec | |
|---|---|---|---|---|---|---|---|---|---|---|---|---|
| | | | | | Y | | | | Bottom | to | to | |
| | | | | x (EtOH | (glyc | | | | layer | sep | sep | |
| EtOH | Gly | H2O | x/y | H2O) | H2O) | Hex | Tol | EtOH | mL | 23° C. | 0° C. | visual |
| 0 | 80 | 20 | 0 100 | | 80 20 | 80 | 10 | 10 | 6.0 | 24 | — | Not |
| | | | | | | | | | | | | clear |
| | | | | | | | | | | | | water |
| | | | | | | | | | | | | on |
| | | | | | | | | | | | | walls |
| 20 | 60 | 20 | 25/75 | 80 20 | 80 20 | 80 | 10 | 10 | 5.8 | 25 | — | Not |
| | | | | | | | | | | | | clear |
| | | | | | | | | | | | | water |
| | | | | | | | | | | | | on |
| | | | | | | | | | | | | walls |
| 22 | 68 | 10 | 25/75 | 90 10 | 90 10 | 80 | 10 | 10 | 5.8 | 35 | — | Not |
| | | | | | | | | | | | | clear |
| 35 | 35 | 30 | 50/50 | 70 30 | 70 30 | 80 | 10 | 10 | 5.6 | 14 | 14 | Clear |
| | | | | | | | | | | | | T6 |
| | | | | | | | | | | | | B14 |
| 40 | 40 | 20 | 50/50 | 80 20 | 80 20 | 80 | 10 | 10 | 5.9 | 20 | — | Not |
| | | | | | | | | | | | | clear |
| 45 | 45 | 10 | 50/50 | 90 10 | 90 10 | 80 | 10 | 10 | 5.6 | 35 | — | Not |
| | | | | | | | | | | | | clear |
| 60 | 20 | 20 | 75/25 | 80 20 | 80 20 | 80 | 10 | 10 | 5.8 | 10 | 10 | clear |
| 68.75 | 21.25 | 15 | 75/25 | 85 15 | 85 15 | 80 | 10 | 10 | 5.7 | 20 | — | clear |
| 67.5 | 22.5 | 10 | 75/25 | 90 10 | 90 10 | 80 | 10 | 10 | 5.9 | 33 | — | clear |
| 72 | 13 | 15 | 85/15 | 85 15 | 85 15 | 80 | 10 | 10 | 5.8 | 30 | — | clear |
| 72 | 8 | 20 | 90/10 | 80 20 | 80 20 | 80 | 10 | 10 | 6.0 | 12 | 12 | clear |
| 81 | 9 | 10 | 90/10 | 90 10 | 90 10 | 80 | 10 | 10 | 6.6 | 28 | — | clear |
| 76 | 4 | 20 | 95/5 | 80 20 | 80 20 | 80 | 10 | 10 | 5.9 | 10 | 13 | hazy |
| 66.5 | 3.5 | 30 | 95/5 | 70 30 | 70 30 | 80 | 10 | 10 | 5.9 | 13 | T10 | Sl |
| | | | | | | | | | | | B25 | hazy |
| 70 | 0 | 30 | 100/0 | 70 30 | — | 80 | 10 | 10 | 5.6 | 8 | 17 | clear |
| 80 | 0 | 20 | 100/0 | 80 20 | — | 80 | 10 | 10 | 6.4 | 10 | — | Not |
| | | | | | | | | | | | | clear |
| 90 | 0 | 10 | 100/0 | 90 10 | — | 80 | 10 | 10 | 12.0 | 240 | — | Light |
| | | | | | | | | | | | | haze |
| 80 | 0 | 20 | 100/0 | 80 20 | — | 90 | 10 | — | 5.2 | 6 | — | Not |
| | | | | | | | | | | | | clear |
| 90 | 0 | 10 | 100/0 | 90 10 | — | 90 | 10 | — | 5.9 | 27 | — | clear |

The present application further relates to a refueling system (15) for a vehicle (25) having a fuel management system (10) described herein. The refueling system (15) further includes a fuel dispenser (35) capable of being temporarily fluidly connected to a gasoline source and an anti-knock source, the fuel dispenser comprising a dispenser control system (45) and a fuel dispensing assembly (55). The fuel dispensing assembly (55) is able to deliver the gasoline source, anti-knock source or a mixture thereof from the fuel dispenser (35) simultaneously or sequentially to the fuel tank (60); the dispenser control system (45) is able to detect a fuel processor (30), receive data from the fuel processor (30) and transfer data to the fuel processor (30).

The fuel dispenser (35) may be located at public gas stations, petrol stations or private refueling stations. Such stations allow for users to refuel vehicles having the fuel management system (10) described herein, but also allow for refueling of vehicles that do not have the fuel management system (10) described herein.

The dispenser control system (45) of the refueling system (15) controls the delivery of the gasoline source, anti-knock source or a mixture thereof. The refueling system (15) may further comprise a signaling system capable of signaling either audibly with an audible signal or visually with a visual signal. The signal will communicate to a user that the dispenser control system (45) of the refueling system (15) is seeking information from the fuel management system (10) or the fuel processor (30) of the vehicle (25). If no fuel management system (10) or fuel processor (30) is found by the dispenser control system (45), the fuel dispenser (35) will act as a standard fuel dispenser and will not allow for dispensing from the anti-knock source. The signaling system will utilize at least one signal that the dispenser control system has not found a fuel management system (10) or fuel processor (30) to the user and that no anti-knock agent will be dispensed. Therefore, a user will understand that only gasoline or gasohol will be dispensed to their vehicle. The anti-knock agent may have corrosion issues arise with older vehicles which do not have a fuel management system (10) such as that described herein, as such it is important to have a refueling system (15) where standard gasoline or gasohol can be delivered without dispensing a anti-knock agent such as the one described herein.

If a fuel management system (10) or fuel processor (30) be found and communicated with, the signaling system utilizes at least one signal, the signal signaling that the dispenser control system (45) is seeking information from the fuel management system (10) or the fuel processor (30) and signaling that the dispenser control system (45) has successfully received information from the fuel management system (10) or the fuel processor (30). Therefore, a user will understand that communication has been established and that the refueling can begin. In one embodiment, the signaling system utilizes an audible or visual signal.

The information sought by the dispenser control system (45) may include any information necessary for a successful refueling of the vehicle (25). In one embodiment, the fuel management system (10) or the fuel processor (30) will collect and store information to be retrieved by the dispenser control system (45) including (a) vehicle type including tank size; (b) past history of enhancer usage or gasoline usage; (c) gasoline level in vehicle tank prior to pumping; (d) anti-knock agent level in vehicle tank prior to pumping; (e) user input for fuel by amount in cost; (f) user input for fuel by amount in volume; (g) user input for fuel by amount for filling up the fuel tank; and (h) combinations thereof.

Other information that may be exchanged or shared between the dispenser control system (45) and the fuel management system (10) or the fuel processor (30) is data to deliver the gasoline source, the anti-knock source or a mixture thereof in compliance with governmental regulations. Alternatively, the information may reset or modify the fuel management system (10), including reprogramming the amount of antiknock agent to be used above minimums as may be dictated by national or local government regulations. By “government regulations” it is meant that governmental laws or regulations relating to the contents of gasoline, such as the levels of ethanol in gasohol.

In one embodiment, the dispenser control system (45) is able to transfer data to the fuel management system (10) or the fuel processor (30) to terminate the operation of the vehicle (25) engine (20) while the gasoline source, anti-knock source or a mixture thereof is being fluidly transferred or dispensed from the fuel dispenser (35) to the fuel tank (60). In one embodiment, the dispenser control system (45) transfers data to the fuel management system (10) or the fuel processor (30) to switch on the engine (20) of the vehicle (25) after payment for the delivery of the gasoline source, anti-knock source or a mixture thereof is received. In another embodiment, the dispenser control (45) system transfers data to the fuel management system (10) or the fuel processor (30) to switch on the engine (20) of the vehicle (25) after the gasoline source and the anti-knock source have substantially separated such as a temperature programmed time delay until separation occurs. In another embodiment, the dispenser control (45) system transfers data to the fuel management system (10) or the fuel processor (30) to switch on the engine (20) of the vehicle (25) after sufficient time has passed to remove vapors from the entrance of the fuel tank (60), preferably a gas cap area leading to the fuel tank (60). It may signal that the fuel dispensing assembly (55) may be removed from fuel tank (60) the vehicle (25).

The communication between the vehicle (25) and the fuel dispenser (35) may be accomplished via electronics which may include traditional transponder-type electronics. For example, the transponders may incorporate Texas Instruments RFID technology as well as the MICRON MICROSTAMP® produced by Micron Communications, Inc., 8000 South Federal Way, Boise, Id. 83707-0006. Attention is drawn to U.S. Pat. Nos. 5,621,913; 5,608,739; 5,583,850; 5,572,226; 5,558,679; 5,557,780; 5,552,743; 5,539,775; 5,550,650; 5,497,140; 5,479,416; 5,448,110; 5,365,551; 5,325,150; and 5,302,329 owned by Micron Technology, Inc.

The fuel dispensing assembly (55) transports the gasoline source, the anti-knock agent source or mixtures thereof to the fuel tank (60). In one embodiment, the refueling system comprises a pump system capable of transporting a mixture of the gasoline source and the anti-knock agent source to the fuel tank. The fuel dispenser (35) allows for the transport through the fuel dispensing assembly (55) of a mixture of the gasoline source and the anti-knock agent source to the fuel tank (60) of the vehicle (25) such that the transport of the anti-knock agent source is terminated before the termination of the gasoline source. This allows for any residual anti-knock agent to be washed clean of the fuel dispensing assembly (55). This allows for the fuel dispenser (35) to be safely utilized by vehicles having the fuel management system (10) and vehicles that do not have the fuel management system and must avoid a separate aqueous antiknock phase.

The fuel dispensing assembly (55) is capable of being temporarily fluidly connected to a single fuel source (60) of a vehicle (25) and may comprise a hose in fluid communication with the gasoline source and the anti-knock agent source and a pistol grip nozzle. The pistol grip nozzle should be insertable into a receiving orifice of the fuel tank (60) or a pathway which leads to the fuel tank (60). The pistol grip nozzle may further have a means that a user can depress or move to begin the fluid transfer of the gasoline source and/or anti-knock source through the fuel dispensing assembly (55) and into the single fuel source (60) of the vehicle (25).

The fuel dispensing assembly (55) may further comprise a mixing system for mixing the gasoline source and the anti-knock agent source. The mixing system may be a device located within the fuel dispenser (35) such that the gasoline source and the anti-knock agent source are mixed before being transported by the fuel dispensing assembly (55) to the fuel tank (60) of the vehicle (25). The mixing system may be an inline mixer or mixing pump located between the dispenser pumps and the pistol grip nozzle.

Once dispensed into the fuel tank (60), the resulting mixture substantially separates into a gasoline phase and an anti-knock agent phase in less than about 15 seconds at 20° C. and in less than about 30 seconds at 0° C.

In one embodiment of the present application, a system whereby the anti-knock agent is a glycol and water mixture that is distributed separate from gasohol to a service station and the anti-knock agent is mixed at pump (inline mixer or in gas pump) with the gasohol. The anti-knock agent is able to partition or extract a substantial part of ethanol from gasohol and separates as a glycol ethanol water layer in a vehicle fuel tank or fuel tank.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fuel management system for a gasoline engine comprising:
(A) an engine comprising a cylinder;
(B) a fuel processor system;
(C) a knock sensor in communication with the engine and the fuel processor system;
(D) a combustion chamber injector in communication with the fuel processor system, preferably located tangential to the cylinder;
(E) a manifold or a port area; and
(F) a fuel tank comprising:
gasoline in an upper gasoline layer, a gasoline fuel level detection device in communication with the fuel processor system; a gasoline feed fluidly connecting the gasoline in the fuel tank to the manifold or port area; and
anti-knock agent in a lower anti-knock agent layer; an anti-knock agent level detection device in communication with the fuel processor system; an anti-knock agent feed fluidly connecting the anti-knock agent to the injector.

2. The fuel management system of claim 1 wherein the gasoline feed is arranged such that the gasoline layer is transported from the fuel tank, the gasoline layer being substantially free of the anti-knock agent layer.

3. The fuel management system of claim 1 wherein the anti-knock agent feed is arranged such that the anti-knock layer is transported from the single fuel course, the anti-knock layer being substantially free of the gasoline layer.

4. The fuel management system of claim 1 wherein the gasoline fuel level detection device comprises a float having buoyancy to be located on top of the gasoline layer.

5. The fuel management system of claim 1 wherein the anti-knock agent level detection device comprises a float having buoyancy to be located on top of the anti-knock layer, but not having buoyancy in the gasoline layer.

6. The fuel management system of claim 1 wherein the fuel tank further comprises a baffle system to restrict lateral movement of the gasoline layer and the anti-knock agent layer.

7. The fuel management system of claim 1 wherein the anti-knock agent is selected from glycol subagents, water, ethanol, methanol and mixtures thereof.

8. The fuel management system of claim 1 wherein the anti-knock agent comprises a glycol anti-knock subagent is selected from the group consisting of glycerol, ethylene glycol, 1,2-propylene glycol, 1,3-propylene glycol, isobutylene glycol, 1,2-butanediol, 1,3-butanediol, 2,3-butanediol, 1,4-butanediol, C₅ diols, C₆ diols and mixtures thereof.

9. The fuel management system of claim 8 wherein the glycol subagent is selected from glycerol, 1,2-propylene glycol, 1,3-propylene glycol and mixtures thereof.

10. The fuel management system of claim 8 wherein the glycol subagent comprises less than 40% by volume of the anti-knock agent, preferably comprising from about 5% by volume to about 40% by volume of the anti-knock agent.

11. The fuel management system of claim 7 wherein the anti-knock agent is a glycol subagent and water.

12. The fuel management system of claim 7 wherein the anti-knock agent is a glycol subagent, ethanol and water.

13. The fuel management system of claim 7 wherein water comprising at least 10% by volume of the anti-knock agent, preferably water comprising from about 10% by volume to about 30% by volume of the anti-knock agent.

14. A refueling system for a vehicle comprising;
A vehicle comprising a fuel management system of claim 1 and
A fuel dispenser capable of being temporarily fluidly connected to a gasoline source and an anti-knock source, the fuel dispenser comprising a dispenser control system and a fuel dispensing assembly;
wherein the fuel dispensing assembly is able to deliver the gasoline source, anti-knock source or a mixture thereof from the fuel dispenser to the fuel tank; the dispenser control system is able to detect a fuel processor, receive data from the fuel processor and transfer data to the fuel processor.

15. The refueling system of claim 14 wherein the dispenser control system controls the delivery of the gasoline source, anti-knock source or a mixture thereof.

16. The refueling system of claim 14 wherein the fuel dispenser further comprises a signaling system capable of signaling that the dispenser control system of the fuel dispenser is seeking or receiving information from the fuel management system of the vehicle.

17. The refueling system of claim 16 wherein the signaling system utilizes an audible or visual signal.

18. The refueling system of claim 16 wherein the signaling system utilizes at least one signal, the signal signaling that the dispenser control system is seeking information from the fuel processor and signaling that the dispenser control system has successfully received information from the fuel processor.

19. The refueling system of claim 14 wherein the dispenser control system seeks information from the fuel processor comprising
(a) vehicle type including tank size;
(b) past history of enhancer usage or gasoline usage;
(c) gasoline level in vehicle tank prior to pumping;
(d) anti-knock agent level in vehicle tank prior to pumping;
(e) user input for fuel by amount in cost;
(f) user input for fuel by amount in volume;
(g) user input for fuel by amount for filling up the fuel tank; and
(h) combinations thereof

20. The refueling system of claim 14 wherein a pump system transports a mixture of the gasoline source and the anti-knock agent source to the fuel tank.

21. The refueling system of claim 14 wherein the fuel dispensing assembly comprises a mixing system for mixing the gasoline source and the anti-knock agent source.

22. The refueling system of claim 14 wherein the fuel dispensing assembly comprises a nozzle, the nozzle comprising an in-line mixer.

23. The refueling system of claim 14 wherein the mixture, after entering the fuel tank, substantially separates into the gasoline phase and the anti-knock agent phase in less than 15 seconds at 20° C.

24. The refueling system of claim 14 wherein the mixture, after entering the fuel tank, substantially separates into the gasoline phase and the anti-knock agent phase in less than 30 seconds at 0° C.

25. The refueling system of claim 14 wherein the fuel dispenser transports through the fuel dispensing assembly a mixture of the gasoline source and the anti-knock agent source to the fuel tank such that the transport of the anti-knock agent source is terminated before the termination of the gasoline source.

26. The refueling system of claim 14 wherein the dispenser control system transfers data to the fuel processor to switch off the engine of the vehicle.

27. The refueling system of claim 14 wherein the dispenser control system transfers data to the fuel processor to switch on the engine of the vehicle after payment for the deliver the gasoline source, anti-knock source or a mixture thereof is received.

28. The refueling system of claim 14 wherein the dispenser control system transfers data to the fuel processor to switch on the engine of the vehicle after the gasoline source and the anti-knock source have substantially separated.

29. The refueling system of claim 14 wherein the dispenser control system is programmed with data to deliver the gasoline source, the anti-knock source or a mixture thereof in compliance with national or local governmental regulations.
